(19) United States
(12) Patent Application Publication
(10) Pub. No.: US 2025/0025266 A1
(43) Pub. Date: Jan. 23, 2025

(54) METHOD FOR ASSISTING IN ALIGNMENT OF DENTAL PROSTHESIS AND DENTAL IMPLANTS FOR FULL ARCH DENTAL IMPLANT PLACEMENT

(71) Applicant: Hsin-Yu KUO, New Taipei City (TW)

(72) Inventor: Hsin-Yu KUO, New Taipei City (TW)

(21) Appl. No.: 18/504,338

(22) Filed: Nov. 8, 2023

(30) Foreign Application Priority Data
Jul. 19, 2023 (TW) 112126868

(51) Int. Cl. A61C 7/08; A61C 7/00; A61C 7/36; A61C 13/00; A61C 13/34

(52) U.S. Cl. CPC A61C 7/08; A61C 7/002; A61C 7/36; A61C 13/0004; A61C 13/34

(57) ABSTRACT

A method for assisting in alignment of a dental prosthesis and dental implants for full arch dental implant placement includes obtaining a first digital intraoral scan image of a patient's oral cavity, creating a 3D virtual dental prosthesis model serving as a basis for producing the dental prosthesis for the patient, obtaining an adaptive element including a prosthetic prototype that is produced based on the 3D virtual dental prosthesis model and a plurality of matching indicators that are attached on the prosthetic prototype according to preset conditions, obtaining a second digital intraoral scan image and a tomographic scan image of the patient's oral cavity when the adaptive element is attached to a gum of the patient, and outputting a plan for implanting the dental implants into the patient's alveolar bone based on the second digital intraoral scan image and the tomographic scan image.

### CROSS-REFERENCE TO RELATED APPLICATION

This application claims priority to Taiwanese Invention patent application No. 112126868, filed on Jul. 19, 2023, and incorporated by reference herein in its entirety.

### FIELD

The disclosure relates to a method for assisting in full arch dental implant placement, and more particularly to a method for assisting in alignment of a dental prosthesis and dental implants for full arch dental implant placement.

### BACKGROUND

Full arch dental implant placement provides full arch restoration for a patient with complete tooth loss or about to undergo full tooth extractions. In a conventional full arch dental implant procedure, detailed images of part of a patient's oral cavity (either an upper jaw or a lower jaw) are obtained by computed tomography (CT) scan technique. Then, a dentist plans a dental prosthesis (e.g., denture) based on the detailed images of the patient's oral cavity, and several dental implants (also known as anchor) are strategically placed in the jaw, and the dental prosthesis is anchored on these implants.

However, improper placement of the dental implants may hinder accurate alignment and connection of the dental prosthesis with to the dental implants. In such case, excessive stress on the dental implants attributed to uneven distribution of pressure on the dental prosthesis may cause mechanical failures or loosening of the dental implants, and ultimately lead to failure of the dental implantation. Furthermore, peri-implant inflammation may happen if there is a gap between the dental implant and the dental prosthesis.

### SUMMARY

Therefore, an object of the disclosure is to provide a method for assisting in alignment of a dental prosthesis and dental implants for full arch dental implant placement that can alleviate at least one of the drawbacks of the prior art.

According to the disclosure, the method includes the following steps. In a step, a digital intraoral scanner obtains a first digital intraoral scan image of an oral cavity of a patient. In another step, a processing device creates, with reference to the first digital intraoral scan image, a three-dimensional (3D) virtual dental prosthesis model serving as a basis for producing a dental prosthesis for the patient. In yet another step, an adaptive element is obtained. The adaptive element includes a prosthetic prototype that is produced based on the 3D virtual dental prosthesis model, and a plurality of matching indicators that are attached on the prosthetic prototype according to preset conditions. In still another step, the digital intraoral scanner obtains a second digital intraoral scan image of the oral cavity of the patient when the adaptive element is attached to a gum of the patient, the second digital intraoral scan image showing the adaptive element that includes the matching indicators. In one other step, a tomographic device obtains a tomographic scan image of the oral cavity of the patient when the adaptive element is attached to the gum of the patient, the tomographic scan image showing an alveolar bone of the patient and the matching indicators. In an additional step, the second digital intraoral scan image and the tomographic scan image are superimposed on each other by aligning the matching indicators to create a superimposed image. In a further step, the processing device outputs, based on the second digital intraoral scan image, the tomographic scan image and the superimposed image, a plan for implanting the dental implants into the alveolar bone.

Another object of the disclosure is to provide an adaptive element for assisting in alignment of a dental prosthesis and dental implants for full arch dental implant placement.

According to the disclosure, the adaptive element includes a prosthetic prototype and a plurality of matching indicators attached on the prosthetic prototype. A number of the matching indicators is from 3 to 10, and a material of the matching indicators has a property of allowing the matching indicators to be accurately and fully captured, represented, and visualized when scanned by both a digital intraoral scanner and a tomographic device.

The other object of the disclosure is to provide a method for producing an adaptive element.

According to the disclosure, the method includes obtaining, by a digital intraoral scanner, a digital intraoral scan image of an oral cavity of a patient; creating, by a processing device, with reference to the digital intraoral scan image, a three-dimensional (3D) virtual dental prosthesis model that serves as a basis for the dental prosthesis; producing, by a 3D forming equipment, a prosthetic prototype based on the 3D virtual dental prosthesis model; and attaching a plurality of matching indicators on the prosthetic prototype according to preset conditions.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a flow chart exemplarily illustrating a method for assisting in alignment of a dental prosthesis and dental implants for full arch dental implant placement according to an embodiment of the disclosure.

FIG. 2 is a first digital intraoral scan image of an oral cavity of a patient.

FIG. 3 is a schematic view of a three-dimensional (3D) oral cavity model of the oral cavity of the patient, which is created based on the first digital intraoral scan image of FIG. 2.

FIG. 4 is an image illustrating a 3D virtual dental prosthesis model that is created with reference to the 3D oral cavity model shown in FIG. 3 and that serves as a basis for the dental prosthesis.

FIGS. 5 and 6 are photographic images of a prosthetic prototype of an adaptive element produced according to the 3D virtual dental prosthesis model.

FIG. 7 is a photographic image illustrating the adaptive element having a plurality of matching indicators attached on the prosthetic prototype.

FIG. 8 is a photographic image of the patient's oral cavity when the adaptive element is attached to the gum of the patient.

FIG. 9 is a second digital intraoral scan image of the oral cavity of the patient when the adaptive element is attached to the gum of the patient.

FIG. 10 is a tomographic scan image of the oral cavity of the patient when the adaptive element is attached to the gum of the patient.

FIG. 11 illustrates an interface of a dental CAD design software and a plan for implanting the dental implants into an alveolar bone.

FIG. 12 is a schematic diagram illustrating full arch dental implant placement.

FIG. 13 is a block diagram of a system for implementing the method for assisting in alignment of a dental prosthesis and dental implants according to an embodiment of this disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

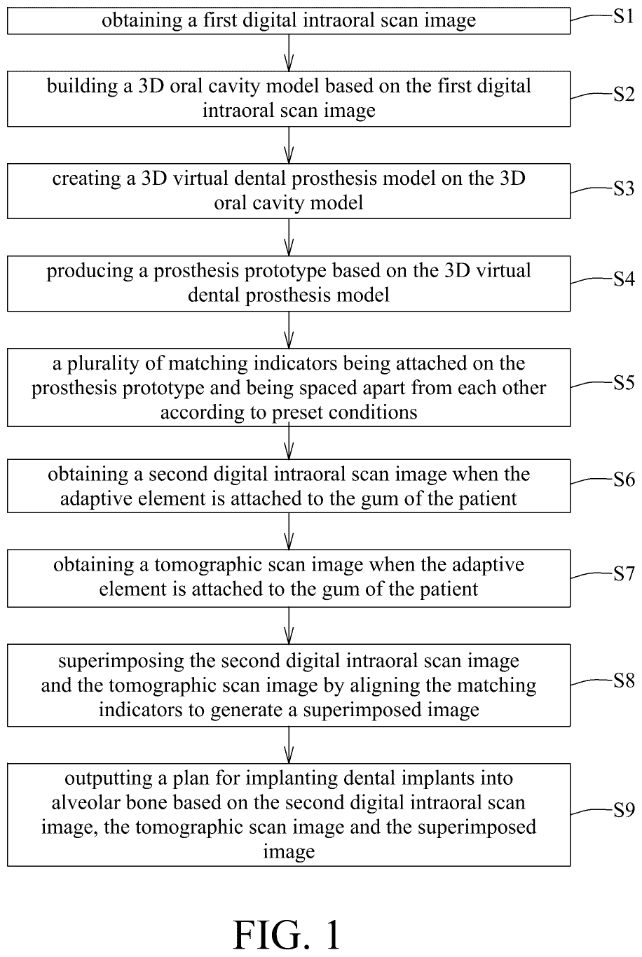

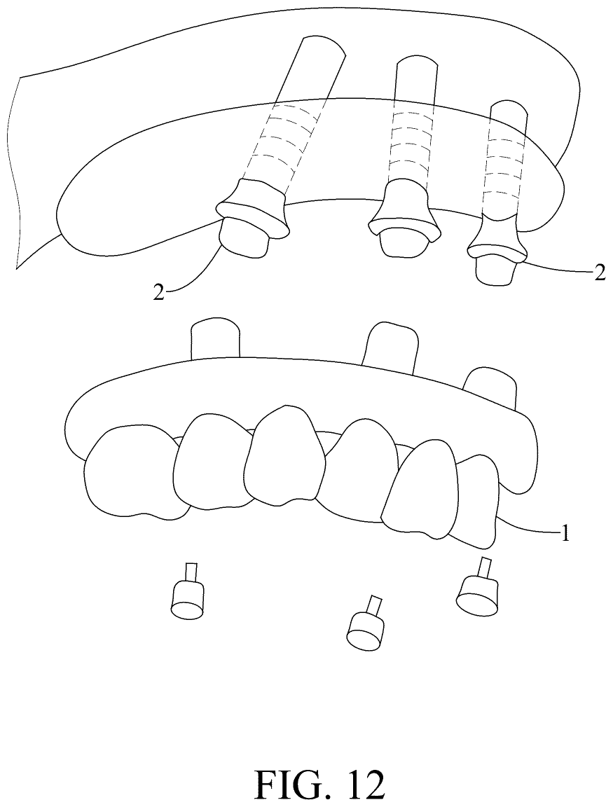

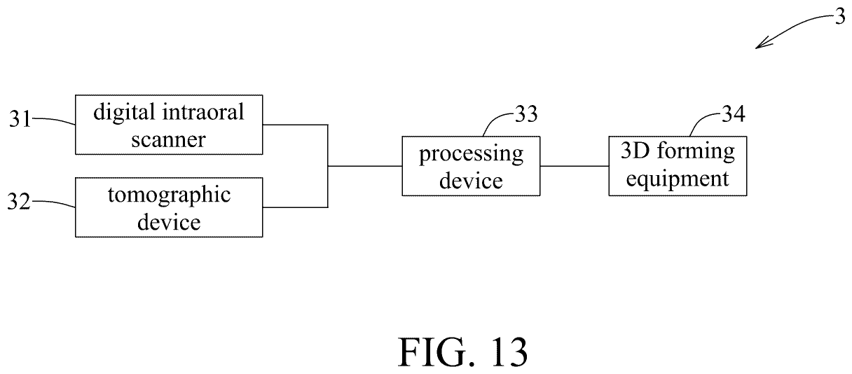

Referring to FIG. 1, an embodiment of a method for assisting in alignment of a dental prosthesis 1 and dental implants 2 (see FIG. 12) for full arch dental implant placement includes steps S1 to S9 as follows. The method is implemented by, for example, a system 3 shown in FIG. 13. The system 3 includes a digital intraoral scanner 31, a tomographic device 32, a processing device 33 that can receive images from the digital intraoral scanner 31 and the tomographic device 32, and a three-dimensional (3D) forming equipment 34 that can receive data from the processing device 33. In this embodiment, the dental prosthesis 1 and the dental implants 2 are used on a patient with complete absence of teeth in the maxilla or a patient who is about to undergo full tooth extractions in the maxilla. In other embodiments, the dental prosthesis 1 and the dental implants 2 may be used on a patient with complete absence of teeth in the mandible, a patient with complete absence of teeth in the full mouth, or a patient with incomplete absence of teeth in the mouth.

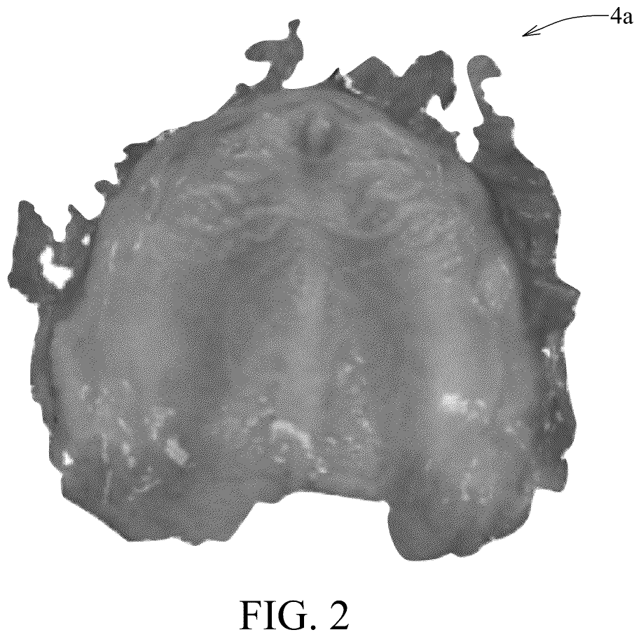

In step S1, the digital intraoral scanner 31 performs an intraoral scan in the oral cavity of the patient to obtain one or more intraoral scan images (e.g., a first digital intraoral scan image 4a shown in FIG. 2). In this embodiment, the digital intraoral scanner 31 may be an intraoral scanner developed and manufactured by 3Shape (e.g., 3Shape TRIOS), or other intraoral scanners.

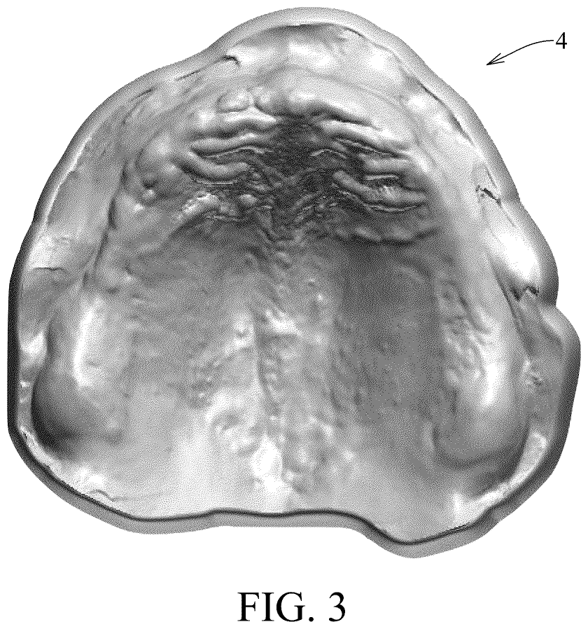

The processing device 33 has a processor, a storage medium and a display (not shown). The processor is, for example, a central processing unit (CPU), or any other general-purpose or special-purpose programmable microprocessor, digital signal processor (DSP), programmable controller, application specific integrated circuit (ASIC), programmable logic apparatus (PLD), graphics processing unit (GPU) or other similar apparatuses, or combinations thereof. The processing device 33 executes a dental CAD design software (e.g., Dental System provided by 3Shape) stored in the storage medium, and the dental CAD design software is configured to generate 3D oral cavity models. In step S2, the processing device 33, after receiving the first digital intraoral scan image 4a from the digital intraoral scanner 31 and displaying the same on the display, builds a 3D oral cavity model 4 representing the patient's alveolar bone as shown in FIG. 3 based on the first digital intraoral scan image 4a.

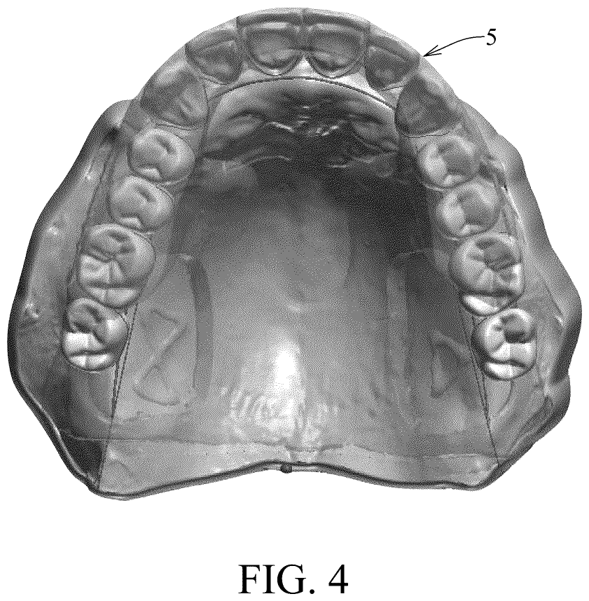

In step S3, the processing device 33 creates a 3D virtual dental prosthesis model 5 on the 3D oral cavity model 4 with reference to the first digital intraoral scan image 4a. Specifically, by means of the dental CAD design software that is executed by the processing device 33, via an operation of a dentist, the 3D virtual dental prosthesis model 5 that represents a digital diagnostic teeth arrangement is designed and created, as shown in FIG. 4. This 3D virtual dental prosthesis model 5 will serve as a basis for the dental prosthesis 1.

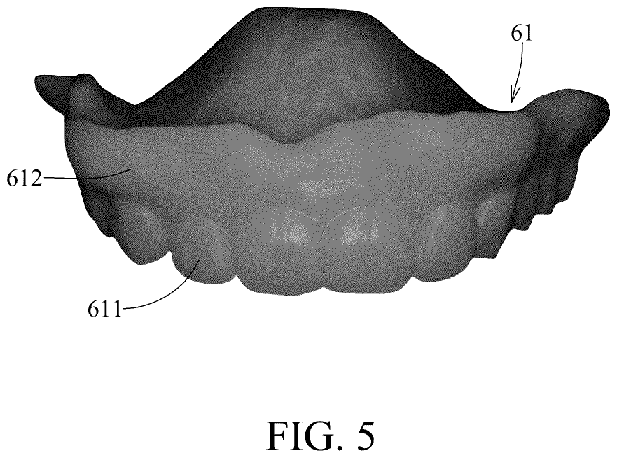

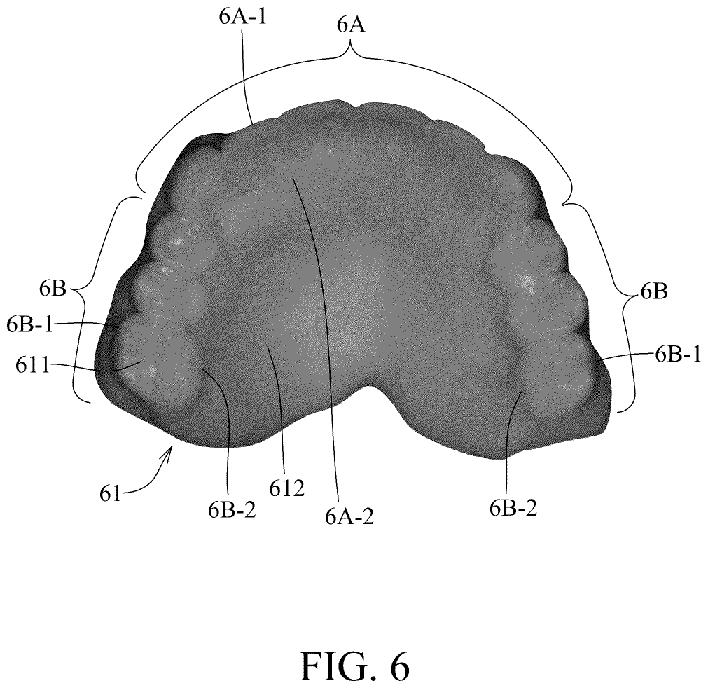

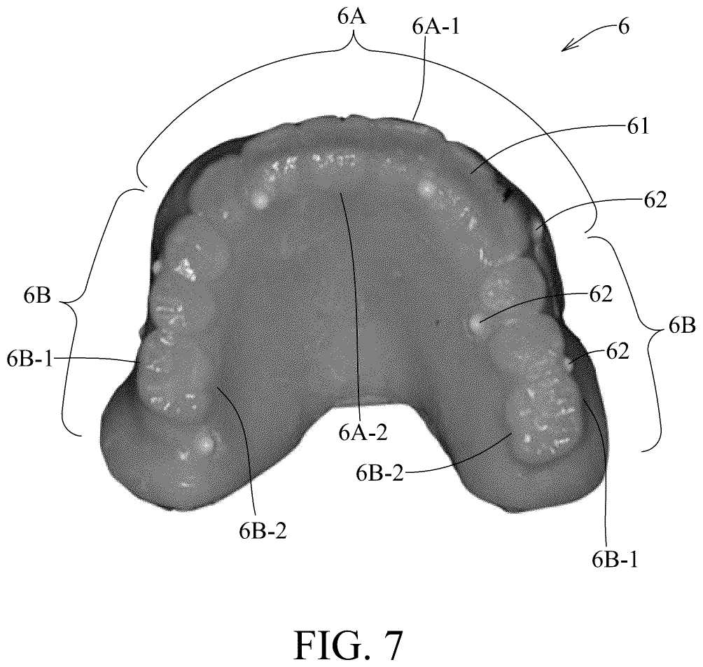

In this embodiment, an adaptive element 6 as shown in FIG. 7 should be obtained for the patient to wear for further scanning and planning (described below). The adaptive element 6 includes a prosthetic prototype 61 (see also FIGS. 5 and 6), and a plurality of matching indicators 62 attached on the prosthetic prototype 61 and spaced apart from each other. Specifically, in step S4, the 3D forming equipment 34 produces the prosthetic prototype 61 based on the 3D virtual dental prosthesis model 5. Since the prosthetic prototype 61 is produced based on the 3D virtual dental prosthesis model 5, the prosthetic prototype 61 has an appearance of the dental prosthesis 1 and has a crown portion 611 and a gingival portion 612. Furthermore, the prosthetic prototype 61 includes an anterior region 6A corresponding to anterior teeth, two posterior regions 6B respectively corresponding to left-posterior teeth and right-posterior teeth. The anterior region 6A has a labial side 6A-1 and a palatal side 6A-2 opposite to the labial side 6A-1. Each of the posterior regions 6B has a buccal (cheek) side 6B-1 and a lingual side 6B-2 opposite to the buccal side 6B-1.

In step S5, the plurality of matching indicators 62 are attached on the prosthetic prototype 61 and are spaced apart from each other according to preset conditions. In some embodiments, the preset conditions include that: the matching indicators 62 are attached to the crown portion 611 near a junction of the crown portion 611 and the gingival portion 612; the number of the matching indicators 62 is from 6 to 10; some of the matching indicators 62 are disposed in the anterior region 6A and some are disposed in the posterior regions 6B; among those of the matching indicators 62 that are disposed in the anterior region 6A, at least one of the matching indicators 62 is disposed on the labial side 6A-1 and at least one of the matching indicators 62 is disposed on the palatal side 6A-2; and among those of the matching indicators 62 that are disposed in the posterior regions 6B, with respect to each of the posterior regions 6B, at least one of the matching indicators 62 is disposed on the buccal side 6B-1 and at least one of the matching indicators 62 is disposed on the lingual side 6B-2. Furthermore, a material of the matching indicators 62 has a property of allowing the matching indicators 62 to be accurately and fully captured, represented, and visualized when scanned by both the digital intraoral scanner 31 and the tomographic device 32. In an example, the material of the matching indicators 62 is zirconium dioxide (ZrO₂). In another embodiment, the number of the matching indicators 62 is from 3 to 10, and the matching indicators 62 should be distributed as widely as possible in three dimensions. That is to say, proper distribution of the matching indicators 62 can prevent the matching indicators 62 from overlapping in images obtained by using dental cone beam computed tomography (CBCT). Further, outlines of radio-opacity images (e.g., images obtained by CBCT) would be continuous and well confined.

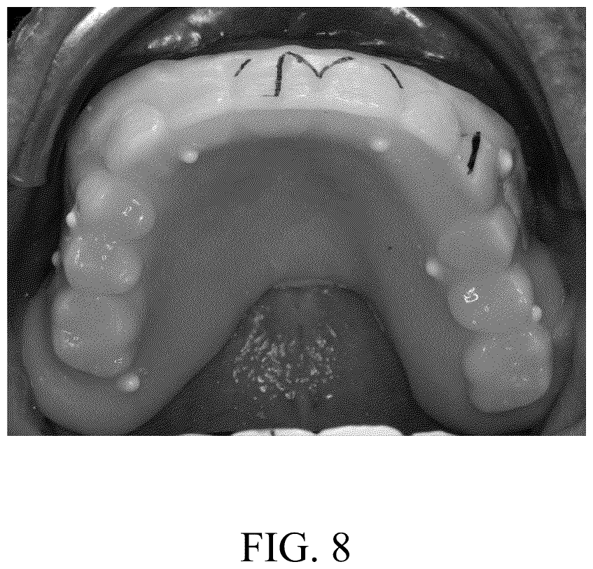

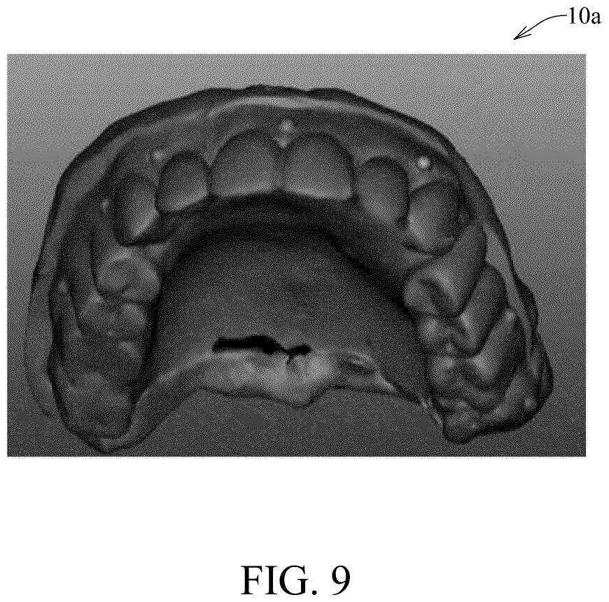

In step S6, the digital intraoral scanner 31 obtains a second digital intraoral scan image 10a (see FIG. 9) of the oral cavity of the patient when the adaptive element 6 is attached to the gum of the patient (see FIG. 8). The second digital intraoral scan image 10a shows the adaptive element 6, inclusive of prosthetic prototype 61 and the matching indicators 62 attached thereon.

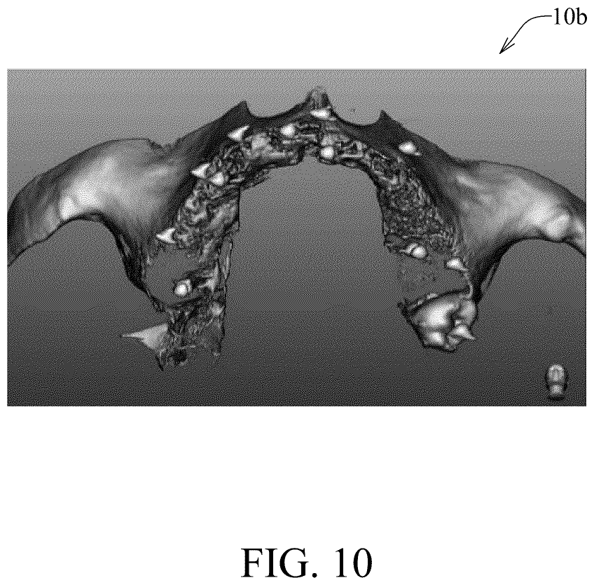

In step S7, the tomographic device 32 obtains, as shown in FIG. 10, a tomographic scan image 10b of the oral cavity of the patient when the adaptive element 6 is attached to the gum of the patient. In this embodiment, the tomographic device 32 is dental cone beam computed tomography (CBCT). The tomographic scan image 10b exclusively shows clear visualization of the patient's hard tissues, such as the alveolar bone, and the matching indicators 62, which are made of the aforementioned material and can be captured by the tomographic device 32. The second digital intraoral scan image 10a and the tomographic scan image 10b can be superimposed on each other by aligning the matching indicators 62 in the second digital intraoral scan image 10a and the matching indicators 62 in the tomographic scan image 10b.

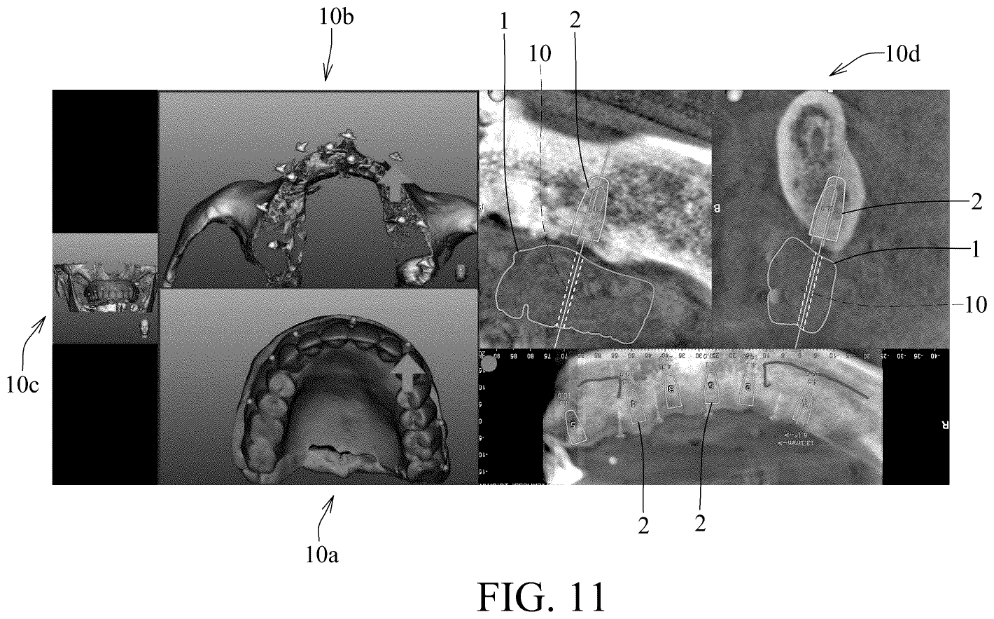

In step S8, the processing device 33 executing the dental CAD design software reads the second digital intraoral scan image 10a and the tomographic scan image 10b, displays the second digital intraoral scan image 10a and the tomographic scan image 10b (e.g., in windows shown on the display of the processing device 33 at the center of FIG. 11), and superimposes the second digital intraoral scan image 10a on the tomographic scan image 10b or vice versa by aligning the matching indicators 62 to generate a superimposed image 10c, and displays the superimposed image 10c (e.g., in a left window shown on the display of the processing device 33, as shown in FIG. 11).

In step S9, the processing device 33 executing the dental CAD design software outputs, via an operation of the dentist, a plan 10d (see FIG. 13) for implanting the dental implants 2 into the alveolar bone based on the second digital intraoral scan image 10a, the tomographic scan image 10b and the superimposed image 10c. As shown in FIG. 13, for each of the dental implants 2, the plan 10d indicates a location and an orientation of the dental implant 2 in the alveolar bone, and a location and an orientation of a hole 10 that penetrates the dental prosthesis 1 and that is aligned with the dental implant 2.

In detail, without using the method disclosed herein, it is not easy for the dentist to plan the locations and orientations of the dental implants 2 only based on the 3D oral cavity model 4 and the 3D virtual dental prosthesis model 5 since there are no reference points. The dental implants that are not planned by the method of this disclosure may not be ideal and may not align with the holes 10 in the dental prosthesis 1 as expected. By creating the adaptive element 6 with the matching indicators 62, the method of this disclosure can provide reference points in the scanned oral images (i.e., the second digital intraoral scan image 10a and the tomographic scan image 10b), to assist the dentist in confirming the location of the digital diagnostic teeth arrangement on the alveolar bone and in planning the locations and orientations of the dental implants 2.

In summary, in the method of the present disclosure, the prosthetic prototype 61 is created based on the 3D virtual dental prosthesis model 5, and the matching indicators 62 are attached on the prosthetic prototype 61 to create the adaptive element 6, which is then attached to the gum of the patient when obtaining the second digital intraoral scan image 10a and the tomographic scan image 10b. Then, the second digital intraoral scan image 10a and the tomographic scan image 10b can be used to plan the locations and the orientations of the dental implants 2 in the alveolar bone, thereby achieving the purpose of assisting in precise alignment of the dental prosthesis 1 and the dental implants 2 for full arch dental implant placement.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for assisting in alignment of a dental prosthesis and dental implants for full arch dental implant placement, comprising:
obtaining, by a digital intraoral scanner, a first digital intraoral scan image of an oral cavity of a patient;
creating, by a processing device, with reference to the first digital intraoral scan image, a three-dimensional (3D) virtual dental prosthesis model that serves as a basis for producing a dental prosthesis for the patient;
obtaining an adaptive element including a prosthetic prototype that is produced based on the 3D virtual dental prosthesis model, and a plurality of matching indicators that are attached on the prosthetic prototype according to preset conditions;
obtaining, by the digital intraoral scanner, a second digital intraoral scan image of the oral cavity of the patient when the adaptive element is attached to a gum of the patient, the second digital intraoral scan image showing the adaptive element that includes the matching indicators;
obtaining, by a tomographic device, a tomographic scan image of the oral cavity of the patient when the adaptive element is attached to the gum of the patient, the tomographic scan image showing an alveolar bone of the patient and the matching indicators,
superimposing, by the processing device, the second digital intraoral scan image and the tomographic scan image on each other by aligning the matching indicators, so as to generate a superimposed image; and
outputting, by the processing device, based on the second digital intraoral scan image, the tomographic scan image and the superimposed image, a plan for implanting the dental implants into the alveolar bone.

2. The method as claimed in claim 1, wherein the step of outputting the plan is to output the plan indicating, for each of the dental implants, a location and an orientation of the dental implant, and a location and an orientation of a hole that penetrates the dental prosthesis and that is aligned with the dental implant.

3. The method as claimed in claim 1, wherein the step of obtaining the adaptive element includes producing the prosthetic prototype by a 3D forming equipment based on the 3D virtual dental prosthesis model.

4. The method as claimed in claim 3, wherein the step of obtaining the adaptive element includes attaching 3 to 10 matching indicators on the prosthetic prototype while keeping the matching indicators spaced apart from each other.

5. The method as claimed in claim 3, wherein the step of obtaining the adaptive element includes attaching six to ten matching indicators on the prosthetic prototype according to following conditions:
some of the matching indicators are disposed in an anterior region of the prosthetic prototype and some of the matching indicators are disposed in two posterior regions of the prosthetic prototype;
among those of the matching indicators that are disposed in the anterior region, at least one of the matching indicators is disposed on a labial side of the anterior region and at least one of the matching indicators is disposed on a palatal side of the anterior region; and
among those of the matching indicators that are disposed in the posterior regions, with respect to each of the posterior regions, at least one of the matching indicators is disposed on a buccal side of the posterior region and at least one of the matching indicators is disposed on a lingual side of the posterior region.

6. An adaptive element for assisting in alignment of a dental prosthesis and dental implants for full arch dental implant placement, comprising:
a prosthetic prototype; and
a plurality of matching indicators attached on said prosthetic prototype,
wherein a number of said matching indicators is from 3 to 10, and a material of said matching indicators has a property of allowing said matching indicators to be accurately and fully captured, represented, and visualized when scanned by both a digital intraoral scanner and a tomographic device.

7. The adaptive element as claimed in claim 6, wherein the number of said matching indicators is from 6 to 10 and said matching indicators are spaced apart from each other according to preset conditions:
some of said matching indicators are disposed in an anterior region of said prosthetic prototype and some of said matching indicators are disposed in two posterior regions of said prosthetic prototype;
among those of said matching indicators that are disposed in the anterior region, at least one of said matching indicators is disposed on a labial side of the anterior region and at least one of said matching indicators is disposed on a palatal side of the anterior region; and
among those of said matching indicators that are disposed in the posterior regions, with respect to each of the posterior regions, at least one of said matching indicators is disposed on a buccal side of the posterior region and at least one of said matching indicators is disposed on a lingual side of the posterior region.

8. The adaptive element as claimed in claim 6, wherein the material of said matching indicators is zirconium dioxide (ZrO₂).

9. A method for producing an adaptive element, comprising:
obtaining, by a digital intraoral scanner, a digital intraoral scan image of an oral cavity of a patient;
creating, by a processing device, with reference to the digital intraoral scan image, a three-dimensional (3D) virtual dental prosthesis model that serves as a basis for the dental prosthesis;
producing, by a 3D forming equipment, a prosthetic prototype based on the 3D virtual dental prosthesis model; and
attaching a plurality of matching indicators on the prosthetic prototype according to preset conditions.

10. The method as claimed in claim 9, wherein the preset conditions for attaching the matching indicators on the prosthetic prototype include that a number of the matching indicators is from 3 to 10, and that the matching indicators are spaced apart from each other.

11. The method as claimed in claim 9, wherein the preset conditions for attaching the matching indicators on the prosthetic prototype include that a number of the matching indicators is from 6 to 10, and that: some of said matching indicators are disposed in an anterior region of said prosthetic prototype and some of said matching indicators are disposed in two posterior regions of said prosthetic prototype;
among those of said matching indicators that are disposed in the anterior region, at least one of said matching indicators is disposed on a labial side of the anterior region and at least one of said matching indicators is disposed on a palatal side of the anterior region; and
among those of said matching indicators that are disposed in the posterior regions, with respect to each of the posterior regions, at least one of said matching indicators is disposed on a buccal side of the posterior region and at least one of said matching indicators is disposed on a lingual side of the posterior region.
